(19) United States
(12) Patent Application Publication
(10) Pub. No.: US 2018/0251924 A1
(43) Pub. Date: Sep. 6, 2018

(54) ENHANCED ICE PEEL RESISTANCE/NON-WOVEN MOLDABLE COMPOSITE SYSTEMS WITH ADDED SOUND ACOUSTICAL PROPERTIES

(71) Applicant: Foss Performance Materials, LLC, Hampton, NH (US)

(72) Inventors: Paul J. Medeiros, Dover, NH (US); Adam Marciniszn, Fremont, NH (US)

(73) Assignee: Foss Performance Materials, LLC, Hampton, NH (US)

(21) Appl. No.: 15/910,547

(22) Filed: Mar. 2, 2018

Related U.S. Application Data
(60) Provisional application No. 62/557,902, filed on Sep. 13, 2017.
(60) Provisional application No. 62/466,289, filed on Mar. 2, 2017.

(51) Int. Cl. D04H 1/435; B29C 43/00; B29B 11/16; B29C 43/02; D04H 1/587; D04H 1/72; B32B 5/26; B32B 5/02; G10K 11/162

(52) U.S. Cl. CPC D04H 1/435; B29C 43/003; B29B 11/16; B29C 43/02; D04H 1/587; B29K 2067/00; B32B 5/26; B32B 5/022; G10K 11/162; B29K 2713/00; B29K 2995/0093; D04H 1/72

(57) ABSTRACT

A nonwoven laminate is provided having multi-purposes. One embodiment is an A-layer having a high surface tension factor to prevent water absorption and can be used for fender liners or underbody surfaces of motor vehicles to prevent water from absorbing into the material as well as ice accumulation. The water resistant properties are the result of utilizing a newly engineered hydrophobic PET (H-PET) fiber. Another embodiment, useable alone or in combination with the A-layer is a B-layer that has hollow multi-lobe cross-sectional fibers to provide enhanced sound absorption properties. One or both layers have thermo-moldable characteristics that allow them to be shaped into a specific geometry. In this case, the low melt fibers provided in one or both layers are “fused” and interlock or bridge together to yield a rigid nonwoven water/ice resistant and/or sound absorbing composite.

### INCORPORATION BY REFERENCE

The following documents are incorporated herein by reference as if fully set forth: U.S. Provisional Application No. 62/557,902, filed Sep. 13, 2017; and U.S. Provisional Application No. 62/466,289, filed Mar. 2, 2017.

### FIELD OF THE INVENTION

The invention relates to the field of nonwoven composites engineered and integrated with specialty-modified fibers or blends thereof that have both hydrophobic and acoustical sound absorption properties. The nonwoven composite is designed for, but not limited to, automotive exterior and interior applications, as a standalone insulator system or a thermoformable part that is thermoformable, for example, by way of having low melt fibers incorporated therein.

### BACKGROUND

A. Ice Peeling

Through the evolution of the automobile, by the mid-1930s fenders became an integral function of the overall auto body engineering to protect the occupants from various materials coming off the rotating tires. Approximately, during around the 1960s, the fender design changed to a more streamline skirt enclosure about the front and rear wheels replacing the bolted fender framed panels. Vehicles today in contrast have singular more aerodynamic unitary quarter panel shields with a dual-purpose wheel housings function.

The overall exterior shape and designing of the automobile today includes the use of lighter weight plastic components that are more economical to produce and assemble. However, these modern plastic forms lack the strength of the metal that they replaced. Therefore, so-called wheel well liners, fender liners and/or mudguard liners evolved to protect the wheel housing, add sound acoustic properties and to add further aerodynamics to the vehicle.

Likewise, the materials applied towards producing such wheel housing liners began quickly to mature. Plastic liners, which did not have very good sound absorption, competed against latex backed nonwoven materials, which were better for sound but only marginally. During the middle 1990s and continuing into 2000s, the technology of manufacturing moldable nonwoven composites using low melt fibers became another alternative. These new moldable nonwoven materials showed improvements in sound absorption among other attributes. See, for example, (B. R. Wyerman; G. C. Jay; Tire Noise Reduction with Fiber Exterior Wheel Arch Liners, 2007). As is often the case, the introduction of new material types can lead to newer problems. Plastic liners for example have surface properties known for preventing ice buildup and for resisting water absorption due to their intrinsic hydrophobic nature, but these plastic versions were typically poor for sound absorption. In contrast, if not treated, fibrous liners have poor water resistance/ice accumulation properties and once exposed to the elements the fibrous liners have a tendency to lose their sound absorbing properties. Furthermore, shape retention could often deteriorate with the fibrous thermoformed liners after wetting out. Therefore, Toyota became one of the first OEMs (Original Equipment Manufacturers) to specify an ice peel test as part of the material specifications, TSL 3618G, July 2013, for exterior parts.

B. Ice Peel Test Method—Discovery Phase

Many, if not all, of the water resistance or water absorption requirements in the OEM material specifications are immersion test methods to determine the effects of swelling corresponding to the physical performance and shape retention of the part. In contrast, the ice peel test is a topical simulation to predict how readily ice buildup around the wheel well liners will separate upon an applied force. As the clearance between the tires and around the wheel housing becomes smaller in order to improve aerodynamics, ice buildup under freezing road and weather conditions could cause damage to the liners, quarter panels, tires and could introduce steering control problems, or even worse a vehicle accident.

The ice peel force tolerance in Toyota TSL 3618G and specified in other OEM Material Specifications must be less than or equal to 10N (Newtons). It was presumed therefore that this value limit was scientifically significant. As a proposed assumption, if the tire's rotation is exposed to ice buildup on a fibrous liner and there is a frictional force of 10N (minimum ice peel force specified in the test), then the applied force needed to maintain constant velocity is the same or 10N. During the initial discovery phase studying different nonwoven constructions, traditional fibrous molded wheel well liners such as 100% polyester composites with low melt binder fibers or composites having blends of polyester/polypropylene fibers (without any added water repellency characteristics) had an ice peel force of 125N+/−38N. Based on these initial findings, there was not only a concern, but also a critical need to invent nonwoven composites that could consistently pass the test.

C. Sound Acoustics

Acoustical insulation and sound absorption is a complex subject. There have been numerous technical publications and engineered materials focused on improving sound absorption. However, despite what is known, there is still considerable emphasis in many fields towards engineering newer constructions and newer products that can further improve the sound absorption capability of materials. The automotive industry is certainly demanding more research & development efforts into noise reduction composites.

When sound waves impinge upon a medium, some of its kinetic energy is converted into low heat energy through mechanical friction, some is absorbed by the medium (deadening the sound), and some is compressed and reflected off the surfaces within the medium. Critical factors, which can affect sound absorption properties within a fibrous nonwoven composite, are the characteristics of fiber size, surface area, airflow resistance, and density. University studies have shown that finer fibers along with more complex cross-sectional fiber structures will provide higher acoustical coefficient values. For example, Fiber Innovation Technologies' (FIT) 4DG fiber is an octalobal cross-sectioned monofilament fiber with significantly more surface area than a circular cross sectional fiber. The 4DG fiber had improved sound absorption priorities compared to similar polymeric monofilament round fibers, (M. Tascan; E. A. Vaughn, Clemson University, Effects of Fiber Denier, Fiber Cross-Sectional Shape and Fabric Density on Acoustical Behavior of Nonwoven Fabrics, Journal of Engineered Fibers & Fabrics Vol 3, Issue 2-2008). In addition, a corresponding study published in 2012 showed that polyester nonwoven composites with a round hollow fiber in the blend had greater sound insulating properties compared to traditional monofilament round polyester fibers, (A. A. Mahmoud; G. F. Ibrahim; E. R. Mahmoud, National Institute for Standards, Using Nonwoven Hollow Fibers to Improve Car Interior Acoustic Properties, RJ TA Vol 16 No. 3, August 2012).

Conventional prior art nonwoven composites used for automotive applications traditionally have fiber blends such as with polyester (PET), low melt co-polyester (CoPET), and polypropylene (PP) fibers. These blends have rounded fiber cross sections and therefore low surface area, a negative for sound absorption. Furthermore, the conventional nonwoven embodiments used for automotive applications presently are manufactured having monofilament staple fibers, not hollow fibers. These non-hollow fiber nonwoven embodiments tend to have greater sound transmission and less intrinsic tortuosity (A. A. Mahmoud; G. F. Ibrahim; E. R. Mahmoud, National Institute for Standards, Using Nonwoven Hollow Fibers to Improve Car Interior Acoustic Properties, RJ TA Vol 16 No. 3, August 2012) and (R. S. Kumar; S. Sundaresan, Acoustic Textiles—sound absorption, College of Technology Coimbatore India).

D. Hollow Fibers

Hollow polymeric fibers, produced by the melt spinning process, are made by having specially engineered arc-like (or C-shaped) slots in the spinneret capillaries within the spin pack section of the extrusion step. During the molten state, there is an open gap or bridge along the C-shaped slot where the filament is not completely hollow until it flows through the capillaries exiting the spinneret and then “coalesces” together into a hollow filament (U.S. Pat. No. 5,330,348, Jul. 19, 1994 and S. P. Rwei, Formation of Hollow Fibers in the Melt-spinning Process, National Taipei University Republic of China, February 2001).

Spinning round hollow fibers is well known. Such fibers are applied in the apparel industry and for high loft insulating materials, and the methodology is a reliable process. Producing a polygonal shaped hollow fiber is also known. For example, Huvis Corporation has announced its intent to market a hollow, non-circular shaped staple fiber-based mat or nonwoven fabric that reduces the fog on windshield of automobiles or act as sound insulators for various other applications. The fiber is shown to be hollow, and include six lobes on its outer surface. Huvis refers to this fiber as “Hexaflower Hollow fiber (HFHF),” and describes the fiber as a 6-petal flower with a hole in the center and is described as thin, light and sound absorbing. However, an absorbent mat or high loft insulating nonwoven fabric made only of hexaflower fibers or some other type of multi-lobe hollow fiber are not appropriate for many applications that require the material to be rigidly shaped in a particular way.

E. Hydrophobic-PET Fibers (H-PET)

Prior art nonwoven composites will use polyolefin fibers, with the most common being polypropylene, that are non-polar and have hydrophobic characteristics. Another available prior art is to topically post-treat the polyester or polyester blended nonwoven with a water repellent (WR) or a fluorochemical (FC) treatment. Both of these approaches show excellent results for passing test methods that require immersing the composite into water; however, neither of these existing treatments have been extensively researched nor are described as being useful for effectively passing the ice peel test.

### SUMMARY

There are two main criteria for passing the ice peel test. One is to yield a peel strength force of 10 Newtons or less; and, the second is not to show any ice formation on the part after the cylindrical jig is pulled off the sample piece. We have discovered through multiple laboratory test studies, that both criteria go hand-in-hand. In all cases, if there is any residue ice formation, the ice peel is greater than 10 N.

Surface tension and surface texture are two factors to resolve in order to pass the Toyota TSL 3618G Ice Peel test. Polyester fibers are naturally hydrophilic or water loving. Polyester is a polar substance and has a high affinity to attract water molecules or for water to be absorbed into the nonwoven composite. Therefore, in order to improve water resistance, the nonwoven's surface tension must be modified. By way of the above-mentioned prior art, this is accomplished with polyolefin fibers or a topical treatment. However, there are deficiencies with both prior art technologies. For example, polyester/polypropylene composites have poor environmental recycling capability, have differential shrinkage reactions when heated during the thermoforming and can have residual mechanical creep or shape deformation when a mechanical stress is applied. Topical treatments also limit recycling, but also can add further environmental and human health risks associated with organic topical treatments.

According to one aspect of the present invention, applying an innovative H-PET fiber within an A-surface layer that is exposed to the ice overcomes these problems. The A-surface layer can be part of a multi-layer laminate. The H-PET fibers can be recycled and the H-PET fibers are based on new chemistry, which does not have the toxic risk factors like C6 or C8 fluorocarbon (FC) chemistry. The process of making the H-PET fiber is accomplished by using conventional melt-spinning methodology. However, during the fiber melt spinning stage or more specifically during the initial blending of the resin ingredients, a master batch compound with a hydrophobic melt additive is introduced. The hydrophobic ingredient comprised within the compound is based on a C4 perfluorinated technology that is available from 3M. Then during the next step or the fiber drawing stage, the hydrophobic C4 additive through a fluid density gradient migrates to the surface of the polyester filament. The physics of migration happens due to the unique polyester property for molecular heat swelling/thermosetting. Therefore, when heating inside the draw-line oven between temperatures of 160 C to 180 C, the fiber's molecular structure swells or opens up allowing the fluid C4 melt additive to form on the surface providing water resistance performance. The water resistant filament is then cut to produce the stable fibers. These staple fibers can then be used alone or in combination with other fibers to form a nonwoven material that can be formed into the A-surface Water Resistant layer.

Further aspects of the invention are described below and in the claims.

### BRIEF DESCRIPTION OF THE DRAWINGS

FIG. 1 illustrates the cross sectional shape of an exemplary hollow, multi-lobal fiber.

FIG. 2 illustrates the cross sectional shape of the low melt fibers.

FIG. 3 illustrates a bi-component low melt fiber with a circular cross section.

FIG. 4 illustrates the A-surface (water resistant) layer laminated to the B-surface (sound absorption) layer.

FIG. 5 illustrates the A-surface (water resistant) layer laminated to the B-surface (sound absorption) layer with a membrane barrier/sound attenuation layer in the middle of the composite between the A-surface layer and the B-surface layer.

FIG. 6 illustrates a single layer composite where water resistance is introduced.

FIG. 7 illustrates a single layer composite where sound absorption is introduced.

FIG. 8 is a flowchart showing the steps for forming a non-woven moldable composite.

FIG. 9 is a flowchart showing the steps for forming hydrophobic polyester fibers.

### DETAILED DESCRIPTION OF THE PREFERRED EMBODIMENTS

Embodiments of a nonwoven laminate 50, 50′ in accordance with the present disclosure, such as shown in FIGS. 4 and 5 can have a triple function purpose. One, the outer A-surface Water Resistant (ASWR) layer 30 has a high surface tension factor to prevent water absorption. If the fender liner or underbody surface is unable to prevent water from absorbing into the material, then ultimately ice could accumulate or crystalize on the surface, will possess high tenacity, and could potentially cause problems as discussed above. In accordance with one preferred embodiment, the water resistant properties are the result of utilizing a newly engineered hydrophobic PET (H-PET) fiber as described below. Second, the B-surface Sound Absorption (BSSA) layer 40 includes a special hollow multi-lobe cross sectional fiber 10. The hollow multi-lobe provides enhanced sound absorption properties. Thirdly, the multilayered composite 50, 50′ has thermo-moldable characteristics whereby the composite (if heated) can be shaped into a specific geometry. In this case, the low melt fibers within the BSSA layer are “fused” (if heated) and interlock or bridge together amongst the hollow multi-lobe fibers to yield a rigid nonwoven sound absorbing composite with added water resistant properties.

Other embodiments can use the ASWR or the BSSA separately to form a single layer component, as shown in FIGS. 6 and 7, in order to provide components with specific properties tailored for certain applications. These single layers also have thermo-moldable characteristics by incorporating low melt fibers whereby the composite (if heated) can be shaped into a specific geometry.

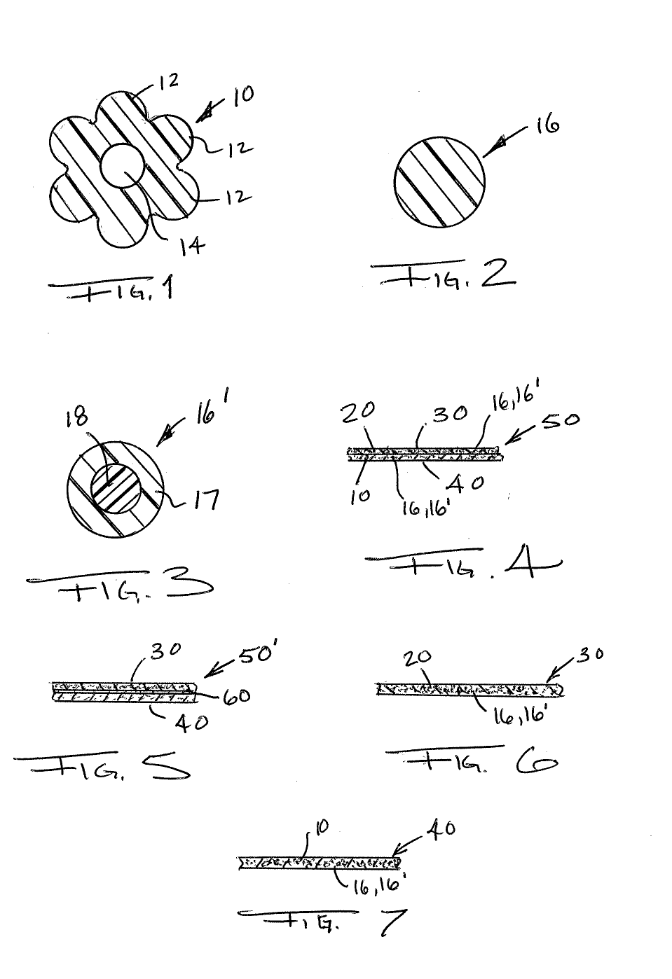

One of the components of the BSSA is a hollow, multi-lobal fiber 10. One embodiment is shown in FIG. 1, which illustrates the cross sectional shape that includes an outer surface having multiple lobes 12, and hollow center core 14. The fiber 10 is preferably made of polyethylene terephthalate (PET). However, other materials for fiber 10 include polybutylene terephthalate (PBT) and Polytrimethylene terephthalate (PTT). While the fiber 10 is shown has having 6 lobes, it can have more than 6, and preferably as few as 5 lobes.

Both the ASWR and BSSA layers may include low melt fibers (LMF) 16. One embodiment of a cross sectional shape of the LMF 16 is shown in FIG. 2 and has a circular cross section. The LMF 16 is preferably made of IPA Modified Co-polyesters, amorphous or semi-crystalline. However, other materials for the low melt fibers include PETG (CHDM Modified Co-polyester) and Polylactate polyester (PLA). Polypropylene fiber (polypropylene is a polyolefin) is another low melt fiber class that can be used. While the circular cross section is one preferred embodiment, other cross-sectional shapes can be utilized.

An alternative bi-component low melt fiber 16′ is shown in FIG. 3. The bi-component LMF 16′ has a circular cross section. The bi-component LMF 16′ includes an outer sheath 17, which is made of low melt polymers, such as those referenced above in connection with FIG. 2. The bi-component LMF 16′ also has a core 18. The core could be hollow or could be of polyethylene terephthalate (PET). The core can also be any of the polymers mentioned above in connection with FIG. 1. The bi-component name references the sheath to core structure.

The LMF 16, 16′ preferably have melting temperatures in the range of 110C to 200C. As mentioned, the LMF 16 or outer sheath 17 of the LMF 16′ can be polyolefin, such as a polypropylene fiber or a polyethylene fiber (PE). Polyethylene fibers can be LDPE, HDPE or modified versions of both having melt temperatures between 115 C to 130 C. Polypropylene (PP) has a melting point of 165 C and is the preferred fiber for certain external automotive applications due for its hydrophobic properties. Co-polyester fibers are another low melt fiber class resulting from the copolymerization of PET with “modifiers”. There are a number of modified co-polyester low melt fibers available with all being applicable for the present embodiment. For example, PETG (polyethylene terephthalate glycol-modified) is a low melt CoPET fiber using cyclohexane dimethanol (CHDM) monomer. Other modifiers that are commonly used to produce low melt co-polyester fibers are isophtalic acid (IPA) and diethylene glycol (DEG). The co-polyester LMF group can be monofilaments or a bi-component having a polyester core or a hollow core.

In contrast, normal polyester fibers (i.e., such as those listed above used for making the hollow, multi-lobal fibers and the H-PET fibers) will melt between 228 C to 260 C (i.e., PET melts at 245 C-260 C, PBT melts at 228 C, and PTT melts at 233 C). Therefore, blending normal high melt polyester fibers with low melt fibers allows the LMF 16, 16′ to melt during thermoforming conditions that “fuses” or “glues” with adjacent hollow, multi-lobe polyester fibers 10 and/or the H-PET fibers 20 (discussed below) together, which then forms an interlocking fibrous matrix that provides rigidity and shape forming characteristics. The LMF 16, 16′ will melt and create a molded material with at least one of sound absorbing or water resistance properties without requiring excessive temperatures that could detrimentally alter the sound absorbing structure of the hollow, multi-lobal fibers.

A-Surface Water Resistant (ASWR) Layer

The ASWR layer 30, included in laminates of FIGS. 4 and 5, and shown as a single layer component in FIG. 6, includes the hydrophobic PET (H-PET) fiber 20 blended with polyolefin fibers, such as polypropylene (PP) or polyethylene (PE), and/or can be blended with co-polyester LMF 16, 16′. The determination of which type of LMF 16, 16′ to apply will depend on the nature of the exterior application and the test protocols. However, studies have shown that PP fibers in the blend with the H-PET fiber 20 provided the best synergy in order to pass the ice peel test.

In one embodiment, the ASWR layer 20 includes a blend ratio of 30% of the H-PET fiber 20 and 70% LMF 16, 16′. However, a blend ratio of as low as 25% or as high as 65% of the H-PET fiber 20 will result in desirable water resistance composites applicable for various performance specifications and applications.

In one preferred embodiment, the H-PET fibers 20 are formed by introducing a master batch compound with the PET during the initial blending step of the melt spinning fiber process. The master batch compound is made up with 80% PBT (polybutylene terephthalate) and 20% melt additive having hydrophobic properties. Either a polyalkylsiloxane based chemistry or perfluorinated based chemistry can be applied to achieve the necessary hydrophobicity properties in making the H-PET fiber. The additive researched and chosen for the present embodiment is based on C4 technology by 3M Company sold under 3M item number L-19329. This is a class of C4 perfluorinated short-chained additives from 3M, which still provide similar surface tension properties as the longer C6 and C8 structures.

The denier of the fiber, the targeted water resistance, overall processing conditions and the fiber manufacturing equipment determines the master batch loading. For the present embodiment, 5% letdown or 1% active C4 additive yielded a high quality fiber with necessary hydrophobic property for ice peel performance. The letdown can however range from 2% to as high as 8%.

The polyester carrier PBT used in the master batch was selected for its low melting point compared to other polyesters. Typical extruder barrel temperatures for melt spinning polyester fibers are around 245 C or above the melt point of PBT, which is 228 C. This differential allows for a more uniform melt dispersion and a higher quality fiber.

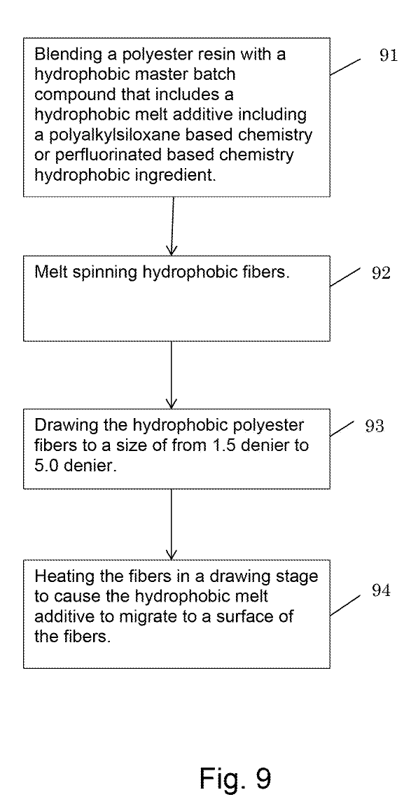

FIG. 9 schematically shows a process for forming the H-PRT fiber 20. In a first step 91, a polyester resin is blended with a hydrophobic master batch compound that includes a hydrophobic melt additive including a polyalkylsiloxane based chemistry or perfluorinated based chemistry hydrophobic ingredient. In a next step 92, after melting the blend in an extruder barrel, the HPET fibers 20 are melt spun through a spinneret. In a next step 93, the H-PET fibers 20 are drawn to a desired size, preferably from 1.5 denier to 5 denier. In another step 94, the fibers 20 are heated in a drawing stage to cause the hydrophobic melt additive to migrate to a surface of the H-PET fibers 20.

B-Surface Sound Absorption (BSSA) Layer—The Composite Blend

The BSSA layer 40 included in laminates of FIGS. 4 and 5, and shown as a single layer component in FIG. 7, preferably includes a blend ratio of 65% of the hollow, multi-lobal fibers 10, and 35% of the LMF 16, 16′. However, a blend ratio of as low as 45% or as high as 95% of the hollow, multi-lobal fibers 10 will result in a desirable, moldable, sound absorbing material depending on the intended level of sound acoustic properties required for the application and/or the rigidity of the formed parts after molding. The combination of both the multi-lobe hollow fiber 10 and the LMF 16, 16′ provide dual functions. First, by containing a LMF 16, 16′, it is thermally moldable to different desired shapes. Once cooled, the material is structurally stable in its molded shape and is ideal for automotive applications such as fender liners/wheel-well liners and underbody systems. Second, the multi-lobal outer surface 12 of the fibers 10, combined with the hollow center core 14, provide superior sound absorbing properties.

General thermoforming methods common in the industry is a compression molding process, which includes a heating zone (IR heating, convection or conductive) and a chilled male/female tooling with a wide range of tonnage applied in order to produce the desired shaped part. The temperature scale for heating the BSSA composite as well as the cycle times will vary depending on the weight of the composite and other parameters. However, top and bottom heating is preferable to uniformly melt the LMF 16, 16′ and provide the required properties to meet certain post testing. General temperature ranges for the thermoforming step in order to fully melt the LMF 16, 16′ is 170 C to 220 C and the cycle times are between 45 seconds to 90 seconds. This is also true for the ASWR layer 30.

Fiber Thickness and Cut Length—B Surface Sound Absorption Layer (BSSA)

Finer fibers will provide better sound acoustics compared to coarse fiber. The preferred embodiment uses fibers 10, 16, 16′ that are either 2, 4 or 6 deniers with a cut length of 51 mm or 76 mm. The criteria for which fiber thickness to use will depend on the applications. For example, if the application is a molded part with a deep radius, a composite with high elongation is best achieved with a thicker fiber (e.g., a 6d fiber). In contrast, composites with less molding contours and draws can be produced with 2 or 4 denier fibers for a more dense composite, which will yield improved acoustical value.

Both the ASWR and BSSA layers 30, 40 in the preferred embodiment can be produced via air layering or by a needle punching operation. The preferred method being the nonwoven needle punch method using two to three looms in a series after carding and cross lapping. Each needle punch loom is setup by having what is known as boards containing felting needles. The specific grades or types of felt needles used will determine the physical density characteristics of the moldable composite necessary for the end application and/or molding methods.

FIG. 4 illustrates one embodiment of the ASWR layer 30 laminated to the BSSA layer 40 that is engineered for passing the ice peel test.

FIG. 5 illustrates the ASWR layer 30 laminated to the BSSA layer 40 with a membrane barrier/sound attenuation layer in the middle of the composite between the A-surface layer and the B-surface layer. This is engineered for passing ice peel and barrier protection.

As shown in FIGS. 4 and 5, these exemplary embodiments can be either classified as double layered or bilam as well as triple layered or trilam constructions. The constructions are assembled by “tacking” when entering the last loom, a down-punched loom. The ASWR layer can be as a single ingredient (FIG. 4) or in combination with a membrane film 60 (FIG. 5) introduced using a roll unwinding station while the BSSA layer is produced through the carding/lapping/needling punching series. An alternate method of producing the bilam construction could be a post lamination process, instead of “tacking”, if the ASWR layer 30 appearance is more critical for the end application. Lamination by the alternate method would require an adhesive web or a flame lamination process.

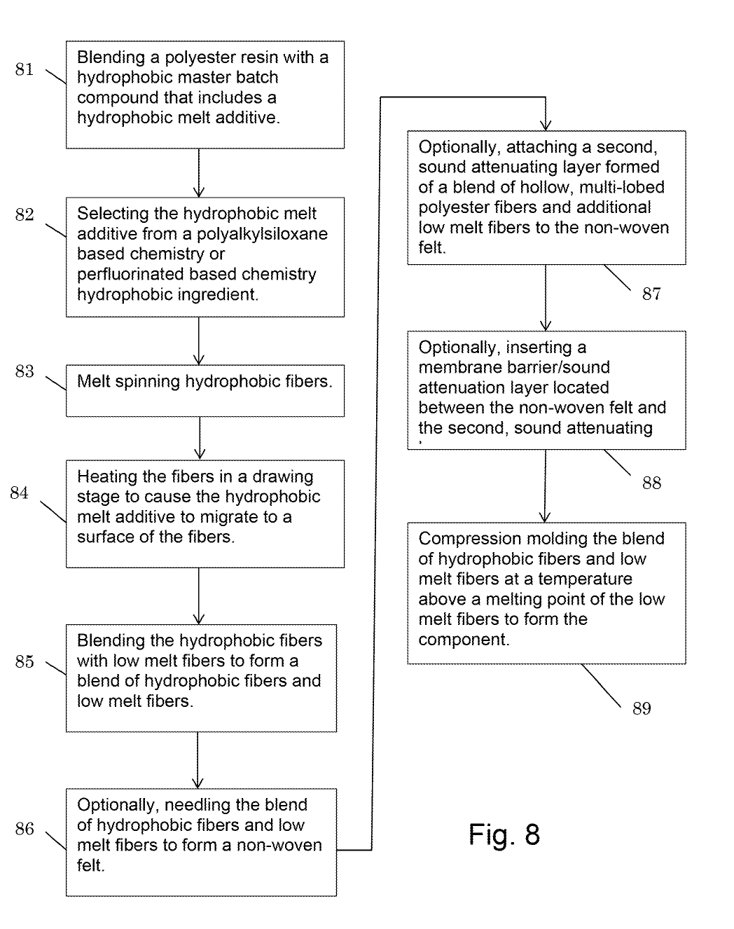

A preferred construction method is illustrated in the flow chart of FIG. 8, in which in a first step 81, a polyester resin is blended with a hydrophobic master batch compound that includes a hydrophobic melt additive. In a sub-step 82, the hydrophobic melt additive is selected from a polyalkylsiloxane based chemistry or perfluorinated based chemistry hydrophobic ingredient. In a next step 83, the hydrophobic fibers 20 are melt spun through a spinneret attached to an extrusion machine. In step 84, the fibers 20 are heated in a drawing stage to cause the hydrophobic melt additive to migrate to a surface of the fibers 20. In a next step 85, after chopping the fibers 20 to a desired length, the hydrophobic fibers 20 are blended with low melt fibers to form a blend of hydrophobic fibers and low melt fibers 16, 16′. In a preferred, but optional next step 86, the blend of hydrophobic fibers 20 and low melt fibers 16, 16′ are needled to form a non-woven felt. In a next step 87, which is optional depending on whether a single ASWR layer 30 is to be formed or the ASWR layer 30 is to be laminated with a BSSA layer 40, a second, sound attenuating layer, the BSSA layer 40, formed of a blend of hollow, multi-lobed polyester fibers and additional low melt fibers is laminated to the non-woven felt provided by the ASWR layer 30. In a next optional step 88, that can be used for forming the trilam construction, a membrane barrier/sound attenuation layer in the form of the membrane film 60 is inserted between the non-woven felt provided as the ASWR layer 30 and the second, sound attenuating, BSSA 40. In a further step 89 that can be performed by part manufacturer's at a different facility who obtain rolls of the material produced as described above, which can just be the ASWR layer 30, a bilam of the ASWR layer 30 and the BSSA layer 40, or a trilam of the ASWR layer 30 and the BSSAA layer 40 with the membrane film 60 therebetween, the blend of hydrophobic fibers 20 and low melt fibers 16, 16′, as well as optionally the BSSA layer 40 and the membrane 60, are compression molded at a temperature above a melting point of the low melt fibers 16, 16′ to form the component.

Fiber Thickness and Cut length—ASWR Layer

Finer fibers will provide more fiber density, a tighter nonwoven structure and a smoother surface texture. Finer fibers also assist on increasing surface tension, which compliments the hydrophobic properties of the fibers. Therefore, fiber fineness ranging from 1.5 denier to 5.0 denier for both the H-PET and the LMF is preferable. As with the BSSA layer, the cut length of 51 mm or 76 mm is preferred.

Mass Weights and Construction Design

A preferred overall weight range for either of the embodiments shown in FIG. 4, 5 or 6 is between 600 gsm to 1200 gsm for underbody, dash insulator fabrics, and fender liners/wheel-wells. The OEM often specifies the range of weight described by its point of application. However, the superior sound absorption advantage from using the hollow, multi-lobal fiber in the BSSA layer could provide lower weight options for automotive design engineers where the bulk of the mass is maintained. Weight range regarding for the ASWR layer is 150 gsm to 300 gsm and is stipulated by the surface area of the fibers and the nonwoven process.

### Alternate Embodiment 1

In one alternate embodiment, the LMF applied in the BSSA layer 40 can have a hollow core as well. This would be similar to the LMF 16′ shown in FIG. 3, except there would be no core material resulting in a hollow core 18. The LMF with the hollow core provides additional acoustic absorption and the hollow shape is largely preserved even after partial melting occurs during the molding process.

### Alternate Embodiment 2

The preferred innovations can be modified for interior applications where ice peel or water-resistance is not a required material specifications. In the case of interior applications, aesthetics for appearance and color are more critical as well as sound acoustic properties. Therefore, for applications where sound quality is a high criteria; examples could be for the map pocket, door insets, load flooring, floor carpets, quarter panels, trunk systems, and headliners, the ASWR layer 30 can be substituted for a nonwoven flat needled or a nonwoven dilour structured carpet combined with the BSSA layer with the multi-lobe hollow/LMF composite. For this alternate embodiment, the weight range of the A-surface layer is between 150 gsm to 650 gsm and the makeup is by using standard monofilament PP, PET, PBT or Nylon fibers.

The present invention is engineered for the objective of enhancing water resistance in order to pass the Toyota Ice Peel test. The present invention likewise has a second purpose on improving sound absorption quality for automotive applications. Potentially, an added and third benefit is where less weight could meet existing standards for automotive exterior or interior parts. This enhancement is accomplished by incorporating two unique new fibers into a nonwoven composite. A complex multi-lobe hollow PET fiber in combination with a hydrophobic PET fiber and mixed with low melt fibers. Due to the nature of the hollow fiber structure, the core is air filled (more bulk), which provides a medium where air molecules enter the pores and undergo reflective compression to deaden sound waves. In addition, the complex multi-lobe cross section provides approximately three times more surface area than compared to traditional round fibers used in prior arts. This added surface area increases sound friction as sound waves pass through the composite and lowers sound transmission as well by doing so. Furthermore, the hydrophobic PET fiber within the A-surface layer has in its science a unique water resistant melt additive in which during polyester fiber manufacturing migrates to the outer surface. When then made into a nonwoven composite it will enhance the surface tension to prevent ice buildup or water absorption.

Additional advantages include: (a) Lower weight options for certain applications having equal sound acoustics—lower energy cost for the vehicle; (b) Improved acoustic coefficient compared to monofilament fibers; (c) Improved sound absorption compared to round cross section fibers; (d) Improved sound absorption compared to a round hollow fiber; (e) Improved sound absorption compared to non-hollow multi-lobal fibers; (f) Improved acoustical coefficient and transmission loss at conventional weights when used in automotive applications; (g) Improved sound absorption after thermoforming, even if in a compressed state; (h) Improved sound absorption before thermoforming or uncompressed state; (i) Improved water resistance compared to prior art to pass the ice peel requirement; (j) Applicable for automotive exterior and interior applications, including but not limited to underbody, fender liners, wheel well liners, dash insulators, map pockets, floor underlayments and assemblies, and trunk systems.

1. A surface water resistant component, comprising
a blend of hydrophobic polyester fiber and low melt fibers that have melting temperatures in a range of 110 C to 200 C, the hydrophobic polyester fiber including polyester and a polyalkylsiloxane based chemistry or perfluorinated based chemistry additive, the blend of hydrophobic polyester fiber and low melt fibers being compression molded at a temperature in the range of 110 C to 200 C.

2. The surface water resistant component of claim 1, wherein the polyalkylsiloxane based chemistry or perfluorinated based chemistry additive is pre-compounded with PBT (polybutylene terephthalate) to form a master batch compound.

3. The surface water resistant component of claim 2, wherein the master batch compound includes 60% to 90% PBT and 10% to 40% of the polyalkylsiloxane based chemistry or perfluorinated based chemistry additive.

4. The surface water resistant component of claim 3, wherein the perfluorinated based chemistry additive is used.

5. The surface water resistant component of claim 4, wherein the master batch compound includes about 80% PBT and about 20% of the perfluorinated based chemistry additive.

6. The surface water resistant component of claim 1, wherein the hydrophobic polyester fiber is from 1.5 denier to 5.0 denier, and the low melt fiber is from 1.5 denier to 5.0 denier.

7. The surface water resistant component of claim 1, wherein there are 25% to 65% of the hydrophobic polyester fibers and from 75% to 35% of the low melt fibers.

8. The surface water resistant component of claim 1, further comprising polyolefin fibers.

9. The surface water resistant component of claim 1, further comprising a B-layer, the blend of hydrophobic polyester fiber and low melt fibers forming an A-layer that is a surface layer, and the B-layer including a blend of hollow, multi-lobed polyester fibers and additional low melt fibers.

10. The surface water resistant component of claim 9, further comprising a membrane barrier/sound attenuation layer located between the A-layer and the B-layer.

11. The surface water resistant component of claim 9, wherein the hollow, multi-lobed polyester fibers are formed of polyethylene terephthalate (PET).

12. The surface water resistant component of claim 9, wherein the hollow, multi-lobed polyester fibers are between 2 and 6 denier.

13. The surface water resistant component of claim 9, wherein the A-layer is about 150 gsm to 300 gsm.

14. The surface water resistant component of claim 9, wherein the component is an underbody, dash insulator fabrics, or fender/wheel-well liner component and is between 600 gsm to 1200 gsm.

15. A method of manufacturing a surface water resistant component from a non-woven fiber blend, comprising:
blending a polyester resin with a hydrophobic master batch compound that includes a hydrophobic melt additive including a polyalkylsiloxane based chemistry or perfluorinated based chemistry hydrophobic ingredient,
melt spinning hydrophobic fibers, heating the fibers in a drawing stage to cause the hydrophobic melt additive to migrate to a surface of the fibers,
blending the hydrophobic fibers with low melt fibers to form a blend of hydrophobic fibers and low melt fibers, and
compression molding the blend of hydrophobic fibers and low melt fibers at a temperature above a melting point of the low melt fibers to form the component.

16. The method according to claim 15, further comprising needling the blend of hydrophobic fibers and low melt fibers to form a non-woven felt prior to the compression molding.

17. The method according to claim 16, further comprising attaching a second, sound attenuating layer formed of a blend of hollow, multi-lobed polyester fibers and additional low melt fibers to the non-woven felt prior to compression molding.

18. A sound attenuating component, comprising
a blend of hollow, multi-lobed polyester fibers and low melt fibers that have melting temperatures in a range of 110 C to 200 C, the blend of hollow, multi-lobed polyester fibers and low melt fibers being compression molded at a temperature in the range of 110 C to 200 C.

19. The sound attenuating component of claim 18, wherein the multi-lobed polyester fibers have at least one of a 2, 4 or 6 denier and a cut length of 51 mm or 76 mm.

20. The sound attenuating component of claim 18, wherein the low melt fibers comprise monofilaments or a bi-component filament having a core.

21. The sound attenuating component of claim 18, wherein he low melt fibers comprise at least one of: a polyolefin fiber, a polypropylene fiber, a polyethylene fiber, a polypropylene fiber, a co-polyester fiber, a polyethylene terephthalate glycol-modified fiber, or a CoPET fiber using cyclohexane dimethanol (CHDM) monomer.

22. A method of forming a hydrophobic polyester fiber, comprising:
blending a polyester resin with a hydrophobic master batch compound that includes a hydrophobic melt additive including a polyalkylsiloxane based chemistry or perfluorinated based chemistry hydrophobic ingredient,
melt spinning hydrophobic fibers, and
heating the fibers in a drawing stage to cause the hydrophobic melt additive to migrate to a surface of the fibers.

23. The method of claim 22, further comprising:
pre-compounding the polyalkylsiloxane based chemistry or perfluorinated based chemistry additive with PBT (polybutylene terephthalate) to form a master batch compound.

24. The method of claim 22, wherein the perfluorinated based chemistry additive is used.

25. The method of claim 22, wherein the hydrophobic polyester fibers are from 1.5 denier to 5.0 denier.
